(19) United States
(12) Patent Application Publication
(10) Pub. No.: US 2013/0149684 A1
(43) Pub. Date: Jun. 13, 2013

(54) PHYSIOLOGICAL SIMULATOR TOOLKIT AND VIEWER

(71) Applicant: Univ Of Florida Research Foundation, Incorporated, Gainesville, FL (US)

(72) Inventors: ZACHARY EZZELL, Gainesville, FL (US); PAUL ANTHONY FISHWICK, Gainesville, FL (US)

(73) Assignee: UNIVERSITY OF FLORIDA RESEARCH FOUNDATION, INCORPORATED, Gainesville, FL (US)

(21) Appl. No.: 13/709,719

(22) Filed: Dec. 10, 2012

Related U.S. Application Data
(60) Provisional application No. 61/569,042, filed on Dec. 9, 2011.

(51) Int. Cl. G09B 23/28

(52) U.S. Cl. CPC G09B 23/28
USPC 434/272

(57) ABSTRACT

An interactive simulation tool and viewer is provided where a user can build upon a defined ontology; specify custom displays of dynamic variables; specify custom meshes; edit the topology of a compartmental model to create different scenarios; and create questions that are integrated-with, and based-upon, the simulation. In addition to the authoring portion, the generated simulation scenarios can then be executed and interacted within the viewer.

### BACKGROUND

In healthcare, human error is one of the main causes of preventable deaths and injuries to a patient. Education and training of practitioners has been shown to improve patient safety and reduce human error. The integration of traditional teaching methods with medical simulations is enabling practitioners to train for complex and/or difficult pathophysiology.

The study of physiology (and pathophysiology) in preparation of providing medical care is often limited by the availability of interactive training resources. For example, mannequin-based simulators for clinical scenario-based situations tend to be expensive to obtain, operate, and maintain. This expense can limit the amount of training and types of training scenarios available to a student or other type of trainee. In addition, textbooks and lecture slides do not enable interaction and exploration. Although web-based and other software-based physiology simulators are available to supplement textbooks and lecture slides, these software simulators tend to vary widely, even for simulating a similar scenario; and when multiple ones of the software simulators are used, inconsistent visualizations may occur. Furthermore, these simulators tend to be non-modular and cannot be edited by the physiology instructor.

To create a simulation, a developer uses a model builder interface to construct an executable simulation model, a X3D or Virtual Reality Markup Language (VRML) editor to create a 3D visualization, and a third graphical interface to connect simulation variables to the visualization parameters (e.g., the position or color of 3D meshes). However, the engineering and technical understanding required by the current development programs make the implementation of simulations difficult for non-programming specialists. Therefore, when authoring a medical scenario, a person with expertise in physiology and medical instruction must work in collaboration with an engineer or programmer to implement a simulation.

### BRIEF SUMMARY

Certain embodiments of the invention provide simulation tools that allow medical instructors and instructional designers to custom-build their own scenarios without requiring the technical expertise of computer scientists or engineers. According to one embodiment, both authoring and viewing capabilities are provided in the subject simulation tools. The authoring capabilities enable non-programmers to implement a custom simulation. The viewer capabilities allow a user to execute the simulation, manipulate variables and settings, and interact with the scene.

Methods and systems are provided that render a 3D visualization co-located with graph-based ontology models. The graph-based ontology models serve as a user-interface for acquiring further knowledge about the visualized scenario. In this manner, ontologies are visualized as graphs in a user interface, facilitating the construction of dynamic models and the corresponding 3D visualizations. Two modalities are provided: a viewer mode, and a designer mode. In the viewer mode, users may interact with the visualizations and explore the dynamics of the scenario. In the designer mode, users may manipulate the ontology graphs and change the graphical properties within the visualization.

Specific embodiments are described herein for use in medical training However, embodiments are not limited thereto.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A and 1B show system architecture views according to certain embodiments of the invention.

FIG. 2 shows a representation of a portion of the Foundational Model of Anatomy Ontology (FMAO) (Rosse and Mejino, “The Foundational Model of Anatomy Ontology.” In: Burger, A. Davidson, Baldock R. (eds), Anatomy Ontologies for Bioinformatics: Principles and Practice, Volume 6 Pages 59-117, London: Springer 2007).

FIG. 3 shows another representation of a portion of the FMAO (Rosse and Mejino, 2007). The “human body” concept serves as the root of the sub-ontology and all relationships shown are of the “has a” type.

FIG. 4 shows a visualization tool interface for authoring and editing CV shock scenarios in accordance with an embodiment of the invention.

FIGS. 5A-5G illustrates a system workflow for building a physiology scenario in accordance with an embodiment of the invention.

FIG. 6 shows a representation of a sub-ontology, which was created from concepts in FMAO illustrated in FIG. 2, as used in the subject visualization system in accordance with an embodiment of the invention. Abstract classes are shown in rectangles and instances are shown in rounded rectangles. Relationships are of type “has a” or “is a.”

FIG. 7 shows a main interface screen of an embodiment of the invention with components including A) a View Options Pane for changing view settings, B) a Loading Pane for loading XML files, C) a Node Creator Pane for adding ontology nodes, D) a Simulation Pane for executing simulations, E) an Ontology Pane for expanding and collapsing ontology nodes, F) an Attribute Pane for setting attributes of ontology nodes, G) a visualization of an infant and anatomy, H) Ontological nodes for scene and infant, connected by a “has a” relationship (i.e., the scene has an infant). The sub-ontology rooted at infant is collapsed and, therefore, not shown

FIG. 8A shows a screen view of a sub-ontology for the heart in accordance with an embodiment of the invention. The heart node is expanded; therefore, all of its subcomponents are visible. The heart is a subcomponent of the infant node, which accounts for a line leading off screen (the edge at the bottom of the screen).

FIG. 8B shows a screen view of the sub-ontology for the heart shown in FIG. 8A but with meshes and textures assigned to ontology nodes in accordance with an embodiment of the invention.

FIG. 9A shows an illustration of the morphing between the collocated Goodwin et al. (2004) model and the 2D layout of the same model.

FIG. 9B illustrates the morphing shown in FIG. 9A as provided with an interface according to an embodiment of the invention.

FIG. 10A illustrates a running simulation of infant cardiovascular physiology with two-second plots for the variables blood volume and pressure of the right atrium according to an embodiment of the invention.

FIG. 10B shows a close-up view of the variable plots of FIG. 10A.

FIG. 11A shows a screen shot of a portion of the FMAO shown in FIG. 3 with additional concepts visualized in accordance with an embodiment of the invention.

FIG. 11B shows a screen illustrating a result of assigning mesh and material attributes to the concepts human body and heart. The attribute editor is expanded and shows three simulation variables that were added as attributes to the concept left atrium.

FIG. 12A shows a visualization of the Beneken (1965) cardiovascular model collocated with a 3D visualization of the human body and heart in a screen of an embodiment of the invention. The relationship connecting the intrathoracic venous tree concept to the right atrium is selected in the view. When a relationship is selected the control hull becomes visible, allowing users to modify the curvature of the relationship.

FIG. 12B shows a screen of an embodiment of the invention where a plot of the pressure-volume loop is anchored to the left ventricle of the heart mesh. In this screen shot, the ontology is hidden so only the 3D meshes are visible.

FIG. 13 shows a diagram of the influences used to animate the 3D meshes of the heart and human body in accordance with an embodiment of the invention. The arrow denotes a linear mapping between ranges.

FIGS. 14A-14C show snap shots from an executing simulation and visualization of hypovolemic shock. A plot of the electrocardiograph is shown anchored to the heart.

### DETAILED DISCLOSURE

Interactive simulation tools are disclosed herein. Certain embodiments of the invention are directed to providing tools to instructors for creating simulations as they see fit and providing the simulations created by the instructors to trainees for interaction.

Although examples and embodiments are described within the context of medical simulations, and particularly physiology and pathophysiology simulations, embodiments are not limited thereto.

The subject interactive simulation tools can include a viewing portion and a scenario authoring portion.

According to certain embodiments of the invention, the viewing portion of the interactive simulation tool is an interactive, customizable, visualization toolkit that can be used as an exploratory module, where a user executing the simulation can vary elements (such as volume and vascular resistance in a cardiovascular physiology simulation) to understand how these variables interrelate; a diagnostic module, where a user is tested for their understanding of a particular dynamic model generated by the designer; and a constructive module, enabling a user to construct a compartmental model to verify their understanding of the circulatory dynamics.

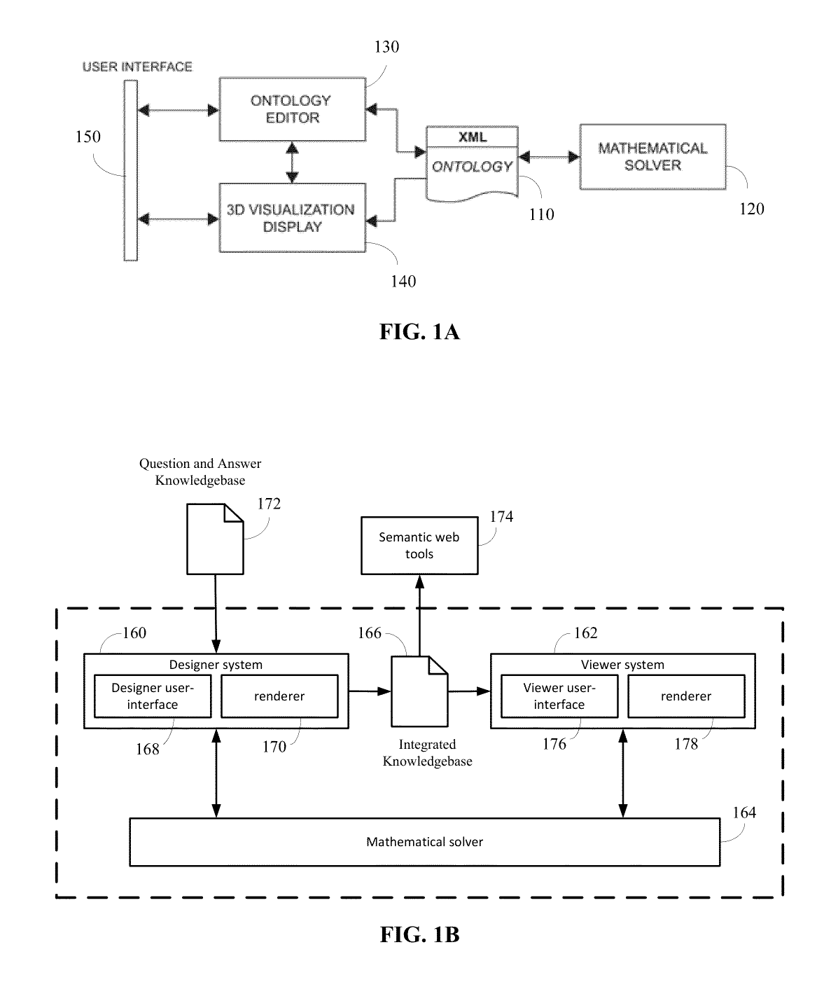

FIG. 1A illustrates the system architecture of a simulation system according to an embodiment of the invention. This system can be categorized as an ontology visualizer and editor, and a simulation model and visualization builder. As shown in FIG. 1A, an ontology database 110 can provide ontology models. A mathematical solver 120 can perform calculations to facilitate a simulation. An ontology editor 130 and 3D visualization 140 can be interacted with via a user interface 150.

“Ontology,” as used herein, refers to the hierarchy of subsuming concepts supplemented with semantic relations that further define how concepts are interrelated.

According to certain embodiments of the invention, the ontologies selected for incorporation in a user interface involve “real world” semantics (e.g., anatomy) without a semantic complexity requirement. The visualized ontology can be leveraged during design time (e.g., to build a dynamic model) or run time (e.g., to label components and denote relationships). Further, ontologies are visualized as graphs and textual labels serve to “verbalize” ontology members. Embodiments of the subject invention allow interaction by a user to change which ontology members are visible and to modify the ontology within the visualization environment.

Table I provides characteristics of ontology usage for certain embodiments of the invention.

TABLE I

| Characteristics | Classifications | | | | |
|---|---|---|---|---|---|
| Domain | Real | IT | Users and | | |
| | world | systems | roles | | |
| Complexity | Informal | Low | Medium | High | |
| Usage | Design | Run time | | | |
| | time | | | | |
| Visualization | None | List | Graphical | Verbalized | Source |
| | | | | | code |
| Interaction | None | View | View and | | |
| | | | edit | | |

As illustrated by Table I, embodiments can provide real world concepts with varying complexity—from informal, low, medium, and high. The models can be implemented for both design time and run time usage and can be visualized both graphically and verbally (e.g., with text or audio). A user can interact with the models through both viewing and editing.

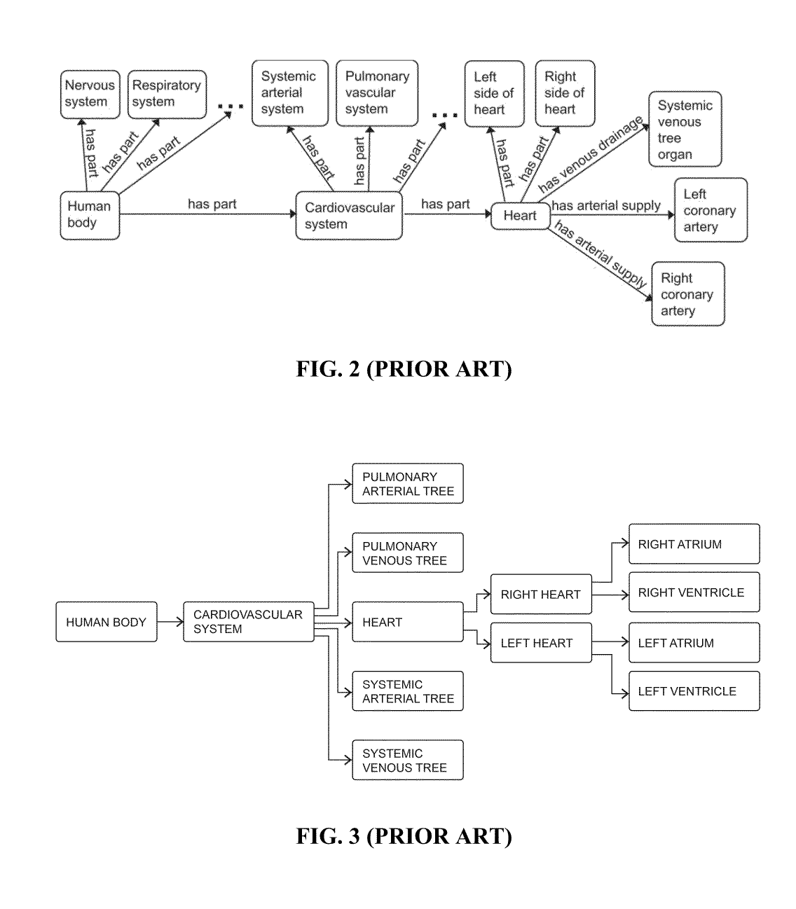

FIGS. 2 and 3 illustrate example representations of the Foundational Model of [Human] Anatomy ontology (FM[H]AO) (Rosse and Mejino, 2007). FM[H]AO is a vast ontology representing anatomical concepts and the relationships between them. FIG. 2 shows a portion of the ontology pertaining to cardiovascular function, and demonstrates the hierarchal nature of the ontology and some of the relationship types within; and FIG. 3 shows another representation and sub-portion of the ontology pertaining to cardiovascular function. Embodiments of the invention can leverage these existing ontologies to create new and/or additional concepts and relationships.

In accordance with embodiments of the invention, the ontology pertaining to a particular domain is placed in the integrative visualization along with the dynamic and graphical models. That is, a user can be presented with both the ontology model and graphics associated with the simulation.

FIG. 1B shows system architecture of an embodiment. The system architecture includes a designer system component 160, a viewer system component 162, a mathematical solver 164 (executing computations via a processor), and a database 166. The system architecture of a simulation system according to an embodiment of the invention such as shown in FIG. 1B results in two user-interface modalities: a designer and a viewer. The designer modality includes modules of a designer user interface 168 and renderer 170 for rendering of 3D geometry and interface components (e.g., textured 3D meshes of anatomical components or 3D graph-based representations of dynamic physiological models). The designer modality enables users (instructors or instructional designers) to interact with and augment a 3D graphical representation of an ontology to create interactive, animated, real-time visualizations of physiological processes.

Within the designer interface (supported by designer user-interface 168), users can define the desired visualization parameters as well as marry existing question and answer knowledge-bases 172 (which may be stored external the system and provided to or accessed by the system) with the user's medical knowledge structures (e.g., ontology and compartmental models). This will permit the efficient design of simulation-centric lesson plans that blend pedagogy with interactive real-time visualizations of physiological processes.

Once a visualization is created in the designer interface (via the designer user-interface 168), the visualization can be saved to the database 166 as an integrated knowledgebase (containing taxonomic, dynamic, visualization, and pedagogic concepts and relationships). The visualization can be encoded in XML. This output file may be encoded in a semantic web-compatible format, such as the Resource Description Format (RDF) for a semantic web tool 174, and thus should be compatible with current and future semantic web tools such as Protégé, an open source ontology editor.

Within the subject simulator system, the information in the integrated knowledgebase can be loaded into the viewer system 162 having a viewer user-interface 176 and renderer 178. Users of the viewer 162 (e.g., physiology students) can then interact with the visualization according to the rules determined during the design phase. The designer may, for example, allow some parameters to be adjustable by a slider while locking others to a constant value. Further, in the viewer system 162 the pedagogy defined by the designer will manifest itself as a lesson with question and answer fields in the viewer.

A two-stage authoring/exploration capability is provided by an embodiment of the subject system. In a specific embodiment for cardiovascular (CV) physiology, a simulation toolkit is provided that allows medical instructors and instructional designers to construct their own scenarios (also referred to as an authoring portion). As part of the exploration portion, (also referred to as the viewing portion), students (and users) can freely explore the simulation, use the simulation in a diagnostic mode where they are given a condition, such as sepsis and then asked to determine what original causes exist to yield that condition, and construct their own models to test their knowledge of compartmental models. The compartmental model, along with the simulation, serves to solidify a mental model in the student for understanding the mechanisms underlying particular medical conditions to which they are being trained.

According to a specific embodiment, an interactive simulation tool and viewer for CV physiology is provided where a user can build upon a defined ontology; specify custom displays of dynamic variables such as blood pressure, volume, and EKG signals within the cardiovascular-based physiology; specify custom meshes of organs and blood vessels; edit the topology of the cardiovascular compartmental model to create different scenarios for shock as well as other cardiovascular pathologies; and create physiology questions that are integrated-with, and based-upon, the simulation. This portion of the interactive simulation tool can be referred to as an authoring toolkit for generating CV physiology scenarios. The generated CV physiology scenarios can then be executed and interacted with using a viewing capability of the subject interactive simulation tool.

Examples of scenarios that may be designed for a CV simulation can include Cardiovascular Physiology, Cardiovascular Shock (cardiogenic, septic, hemorrhagic), and Valvular Disease (aortic valvular stenosis).

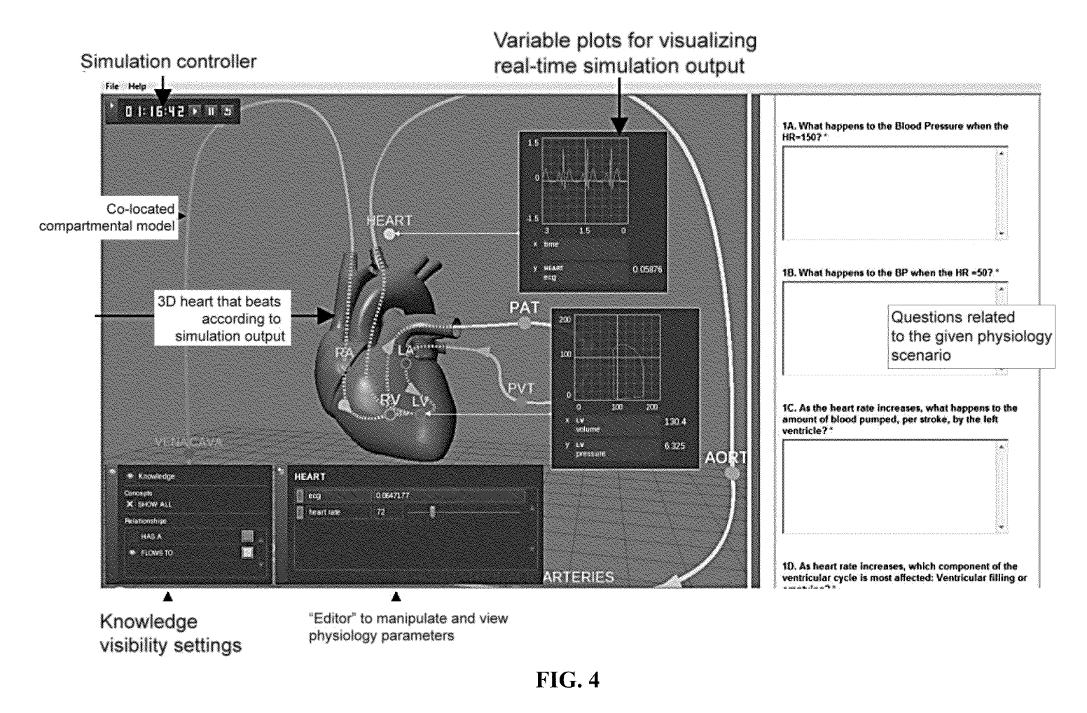

FIG. 4 illustrates an interface for a viewing portion of the interactive simulation tool that may be used in accordance with an embodiment of the invention.

The example shown in FIG. 4 illustrates a basic compartmental model solver and mesh for the heart, which can be considered part of a viewing (or exploration) portion of the simulation toolkit and viewer of an embodiment of the invention. As shown in FIG. 4, an interactive 3D view is provided that includes compartmental models representing physiological phenomena co-located with meshes representing anatomical concepts. Users can analyze the physiology dynamics, by adding plots to the 3D scene.

In FIG. 4, plots of the EKG of the heart and the Pressure-volume loop of the left ventricle are shown. Access to the variable plots can be achieved by selecting the components of the co-located compartmental model (rendered as 3D nodes and edges in FIG. 4) and then dragging the plot into the scene from the “Editor” dock shown in FIG. 4. A guided lesson-plan is given in the right panel of the screen that contains questions that relate to the visualization presented. In this environment a user can examine the effects of each component on a patient. For example, upon initiating the system, the simulation can default to a normal hemodynamic state. A user can alter the patient's cardiac output by an input to an input device (effectively turning a dial or sliding a bar) and the effects on the patient will be seen in real time. As an example of a guided lesson plan, the student can be guided to investigate the most common conditions which have a characteristic hemodynamic anomaly (e.g., in sepsis the systemic vascular resistance is low), and be expected to investigate the physiologic response ad libitum.

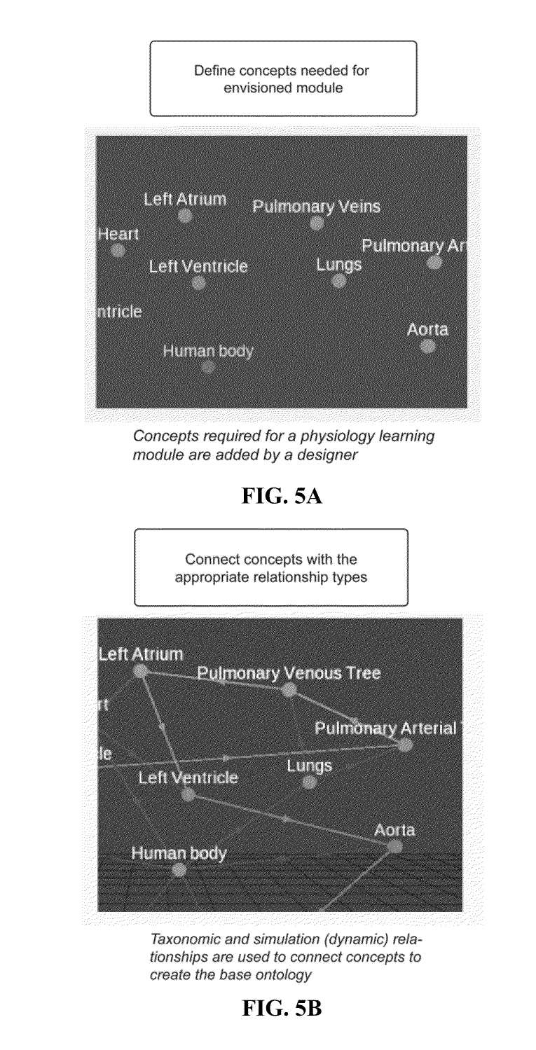

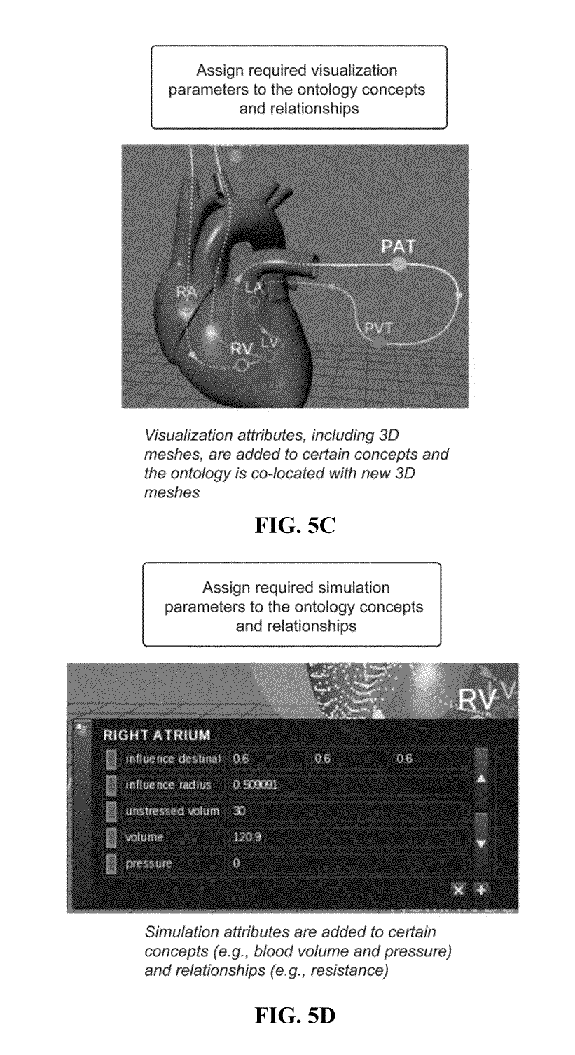

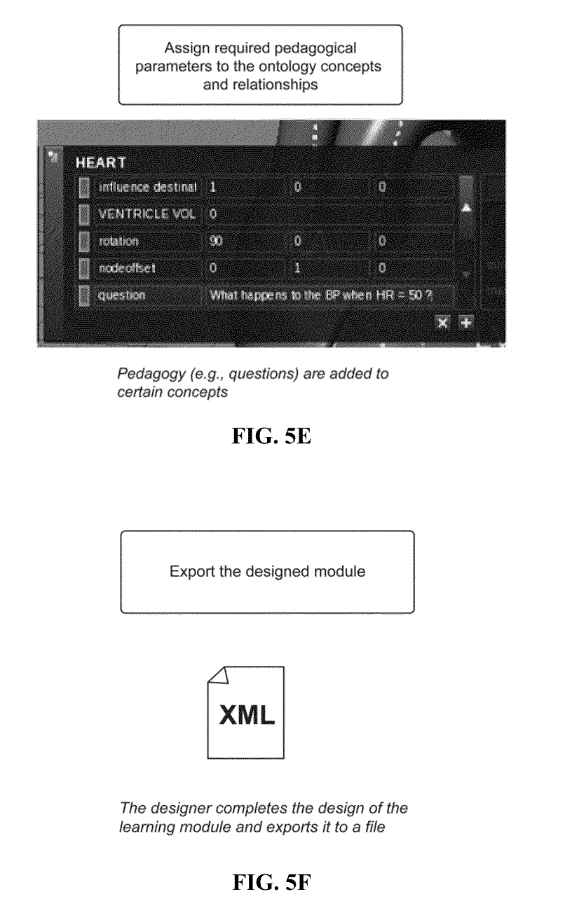

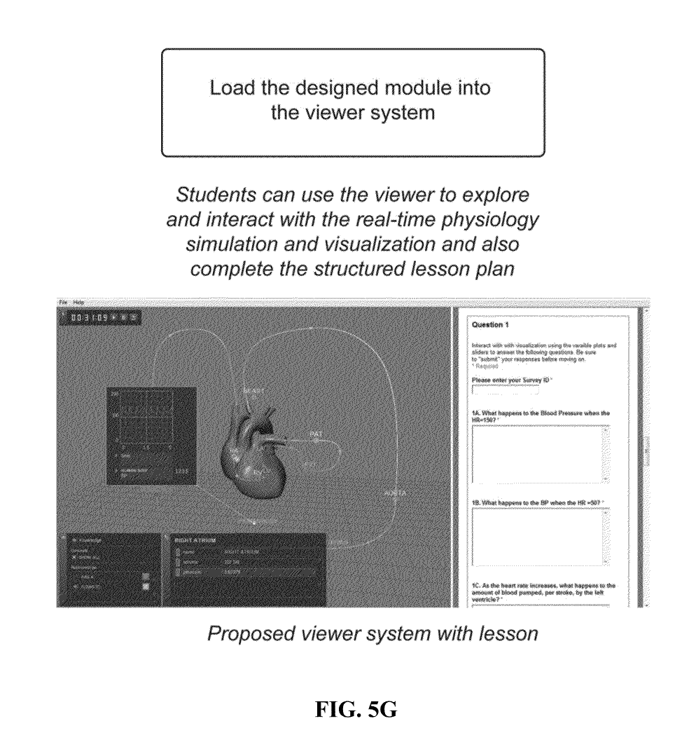

FIGS. 5A-5G illustrate the authoring workflow associated with a medical instructor building a scenario related to cardiovascular physiology or pathology according to an embodiment of the invention. As shown in FIG. 5A, concepts are defined. An ontology can be created or an existing ontology may be used such as FMA (Rosse and Mejino 2003). As shown in FIG. 5B, the defined concepts are then joined by relations, which form the basis of the compartmental model. Next, as shown in FIG. 5C, in a manner similar to “skinning a skeleton” in 3D character rigging for games (see Allen et al. “Body Language: Advanced 3D Character Rigging,” Sybex Publishing 2008; which is hereby incorporated by reference in its entirety), the ontologically-rooted compartmental model is meshed, and other visualization attributes are connected to the underlying ontology. According to certain embodiments, the ontology serves as the “skeleton” for “rigging” the other models. Referring to FIG. 5D, simulation parameters are applied to the underlying ontology, and as shown in FIG. 5E, questions are then related to concepts. Referring to FIG. 5F, this complete product can then be exported to the viewer, which is used by the end-user. This flow can be consistent with semantic web XML-based standards since XML can capture the interchange protocol.

As one example, a physiology learning module of an infant was created as part of a prototype. To create a scenario regarding an infant, the steps presented in FIGS. 5A-5G can be implemented. According to certain embodiments of the invention, an ontology-enabled interface is used as a starting point to build compartmental models and dynamic visualizations. Visualizations can be developed by adding visual attributes, such as 3D meshes and materials, to members of a domain ontology. Compartmental models can be created by adding dynamic edges between members of an ontology to signify flow. After the visualization layout and compartmental model construction, a simulation can be executed that solves the differential equations at each compartment of the model in real-time. The domain ontologies can be reasoned to automate portions of this process. These steps are described in more detail below with reference to the specific embodiment implementation of the prototype example of a physiology learning module of an infant.

### Step 1: Obtaining an Ontology

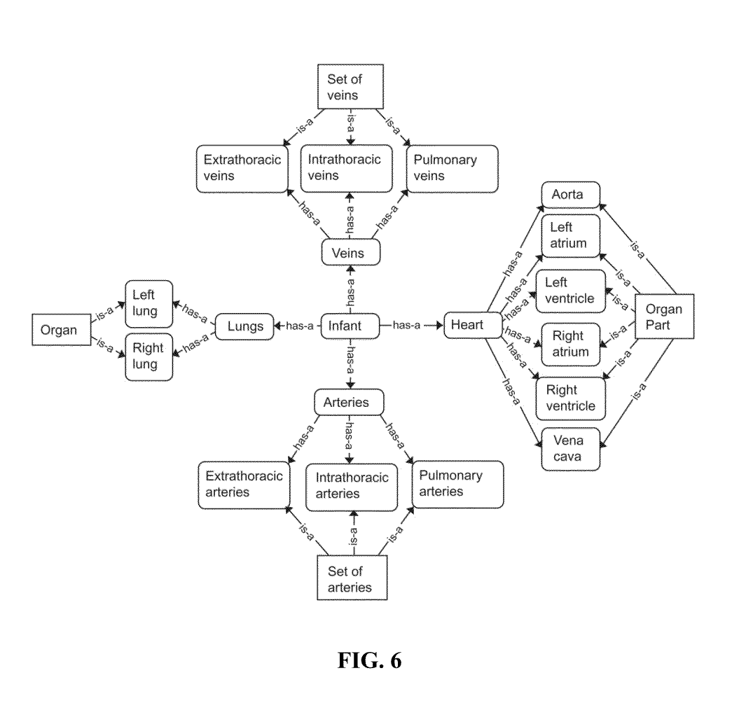

A user can build an ontology by creating nodes, forming relationships between nodes, and assigning the attributes to the nodes. Existing ontologies can be leveraged to create a particular scenario. For example, in one embodiment, the subject system enables a user to load an ontology from a file or author an ontology from scratch by adding nodes and forming named relationships between them. This methodology can be applied to ontologies of any semantic complexity. For instance, a medical practitioner building physiological simulations and visualizations may start with the FMAO as shown in FIG. 2 and then this ontology can be modified for a specific application as shown in FIG. 6, which shows a specific sub-ontology used for the prototype. The ontology can be, for example, in XML or RDF. Once the ontology is created, it can be loaded into the system.

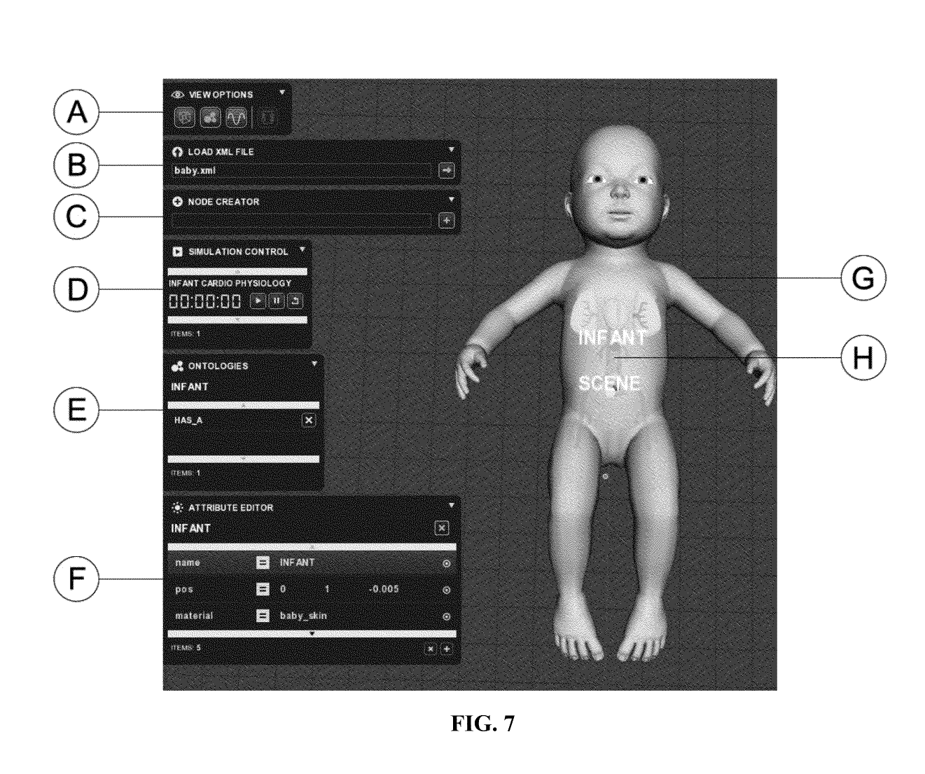

FIG. 7 illustrates an interface of the prototype. Components of the main interface screen shown in FIG. 7 include A) a View Options Pane for changing view settings, B) a Loading Pane for loading XML files, C) a Node Creator Pane for adding ontology nodes, D) a Simulation Pane for executing simulations, E) an Ontology Pane for expanding and collapsing ontology nodes, F) an Attribute Pane for setting attributes of ontology nodes, G) a visualization of an infant and anatomy, H) Ontological nodes for scene and infant, connected by a “has a” relationship (i.e., the scene has an infant). The sub-ontology rooted at infant is collapsed and, therefore, not shown. In the prototype users can control the perspective by rotating and translating a 3D ‘camera’ using mouse controls. FIG. 7 shows a screen shot of the prototype viewer with the interface components labeled. Interface components are docked to the left side of the screen and can be expanded and collapsed.

According to one embodiment, if users wish to create or augment an ontology, they can do so by using the Node Creator Pane, shown in FIG. 7, by entering the name of the node they wish to create and then pressing the create button. A new node with the name given by the user will appear at the origin. When a node is selected, users can view the attribute menu for that ontology member and a 3D mover tool appears that is rooted at the selected node. The mover tool allows users to move the node in the X, Y, and Z directions.

### Step 2: Creating Relationships Between Nodes

To form relationships in the ontology, users employ the graphical interface to add semantic edges between nodes. This is done in the prototype by holding down the left mouse button while the cursor is over a node for a short time until the icon for the Edge Creator Tool appears over the cursor. Users can then drag the Edge Creator Tool to the node they wish to connect to. When the left mouse button is released over a node, an edge is formed, thus creating a relationship in the ontology. The relationships in the example ontology of the heart are of the type “has a,” however the type can be changed by selecting the edge and changing the name of the relationship in the Attribute Pane. After relationships are formed, ontology nodes can be expanded or contracted based on the relationship type. This function is performed in the Ontology Pane, shown in FIG. 7.

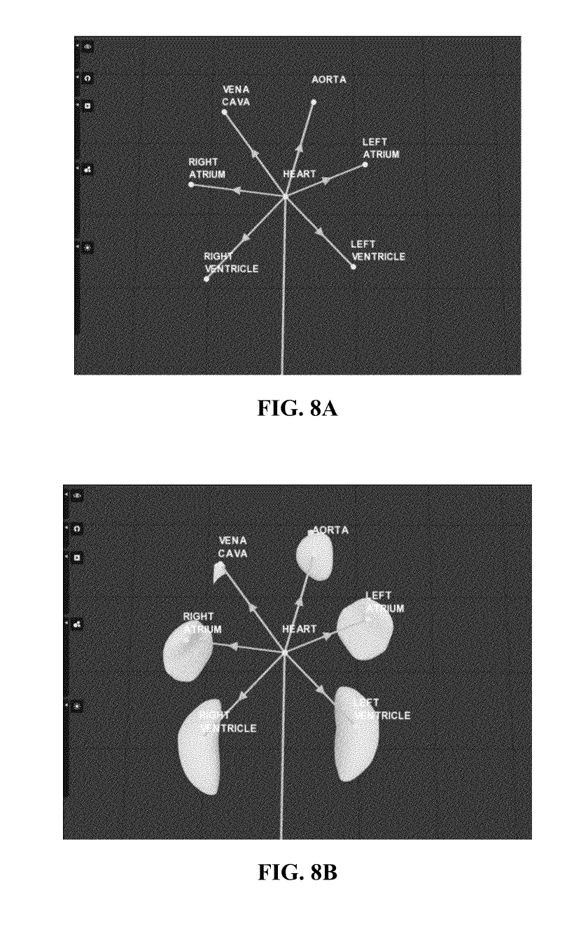

The expanded sub-ontology of “has a” relationships for the heart is shown in FIG. 8A. All of the hearts subcomponents become visible (e.g., vena cava, aorta, etc.). The heart ontology node is a subcomponent of the infant ontology node, which accounts for the edge leading off screen in FIG. 8A.

### Step 3: Adding Attributes to Ontology Nodes

Each of the nodes representing members of the ontology serve as an interface to attributes of that member. When users select a node, attributes become visible in the Attribute Pane, shown in FIG. 7, for that ontology member. The Attribute Pane contains a menu that lists all the attributes of the selected member. Items in the attribute menu can be thought of as terminal members of the ontology. Users can modify entries in the attribute list, or create new entries.

For example, abbreviation is a user-defined attribute that can serve as a shorter label for nodes when the camera is far away in order to simplify the interface. The attribute menu is also the interface that allows users to add visual components to nodes in order to create a complete 3D visualization. When users create a new attribute called mesh or material, the prototype system interprets it appropriately. For efficiency, once an attribute is created for one node (e.g. material=heart material), it can be dragged and dropped to other nodes as a way to copy attributes.

3D meshes in the prototype system are specified in the OGRE .mesh format. For example, materials are specified in the OGRE material format and defined in a .material file. Of course, embodiments are not limited thereto.

FIG. 8B shows the result of assigning the meshes and materials to members of the heart sub-ontology. When meshes are loaded into the system, they stay rooted to the node they are assigned to. Users can move the mesh by using the 3D mover tool attached to the node. Positional offsets of meshes from nodes can also be added by adding the attribute node offset to a given node.

### Step 4: Creating a Dynamic Model

After loading or building an ontology and using it to create a visualization, a compartmental model can be defined. In one embodiment, this is performed by adding new dynamic edges between nodes of the ontology. Edges are added using the Edge Creator Tool described in Step 2. An edge can be either a semantic edge (i.e., part of the base ontology) (which may be displayed in one color), as defined in Step 2, or a dynamic edge (i.e., part of a compartmental model that is added to the ontology) (which may be displayed in a different color from semantic edges). After an edge is added, users can select it and change its type in the Attribute Pane.

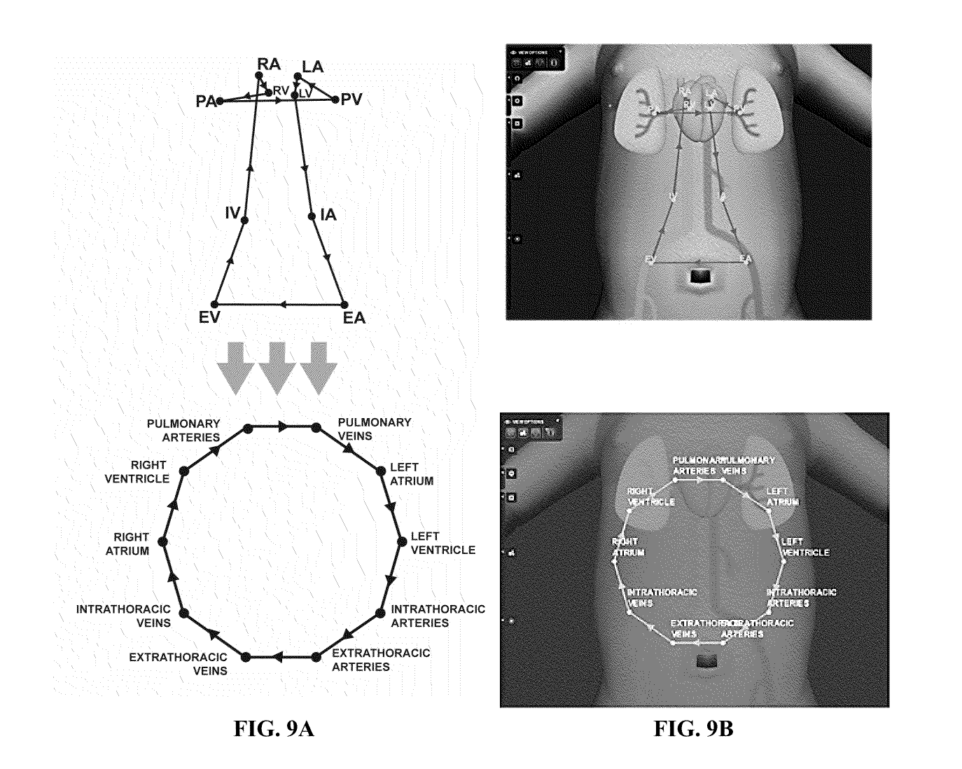

The compartmental model used in the example is defined by Goodwin et al. (“A Model for Educational Simulation of Infant Cardiovascular Physiology,” Anesth Analg 99: 1965-1964 2004) (and shown in FIG. 9A), a variant on the Beneken (“A mathematical approach to cardiovascular function: the uncontrolled human system,” PhD Thesis, Medisch Fysisch Institut TNO 1965) compartmental model for cardiovascular physiology, and is tuned for the cardiovascular system of an infant. The model uses differential equations to represent blood flow through the body. The connectivity of the model is recreated in the system by adding the appropriate dynamic edges between ontology members. Dynamic models can be morphed into a 2D layout, similar to the format found in textbooks. The 2D layout may provide a better insight into the connectivity of the abstract model. Morphing occurs though a fluid animation between the collocated 3D graph and the 2D layout. A depiction of this morphing is shown in FIGS. 9A and 9B. FIG. 9A illustrates the morphing of the compartmental model itself for the sake of clarity. FIG. 9B illustrates the morphing as accomplished and illustrated in the system according to an embodiment of the invention.

Applying first-order logic to the relational semantics embedded in ontologies can benefit the software development process and reduce input required by users. Accordingly, in certain embodiments of the invention, portions of the dynamic model creation can be automated. For example, in the FMAO portion shown in FIG. 2, the ontology class heart has a relationship “has arterial supply.” This relationship can be used to construct a dynamic model representing blood flow where left coronary artery and right coronary artery would be placed as inputs of the heart. Conversely, the relationship “has venous drainage” would place systemic venous tree organ as an output of the heart.

User experiences can also be automatically tailored. For example, using a reasoner, the relationship “has part” can be equated to a labeling depth. The desired depth of anatomy labeling could be provided by the user. Given this depth, the visualization of the ontology can be expanded or contracted appropriately. For instance, expanding the ontology node for the heart would reveal its two parts: left side of heart and right side of heart. The user can continue to increase the labeling depth until all parts of the heart present in FMOA are labeled within the visualization. Users could also choose to keep a high-level view of the anatomy and decrease the labeling level until just the label for heart is visible.

### Step 5: Simulation Execution

The simulation can be executed after the visualization parameters are finalized and the dynamic model is defined. A typical set of equations for a compartment in the Goodwin et al. (2004) model accounts for blood pressure, flow, and change in volume. According to an embodiment of the invention, these simulation variables become attributes of the ontology nodes. In the prototype embodiment, a mathematical solver module is used to solve all the necessary differential equations. Due to the small time-step required to ensure numerical stability when solving the differential equations, the simulation of the prototype embodiment is run in a thread separate from the visualization.

Simulation control options are located in the Simulation Pane, shown in FIG. 7. In order to run the simulation, users are presented in the interface with options to play, pause, or reset “Infant Cardio Physiology.” Play will begin to update values at each time step. Pause will suspend the simulation at the current time but allow for continued play in the future. Reset will set the simulation time to zero and set all variables to their initial state.

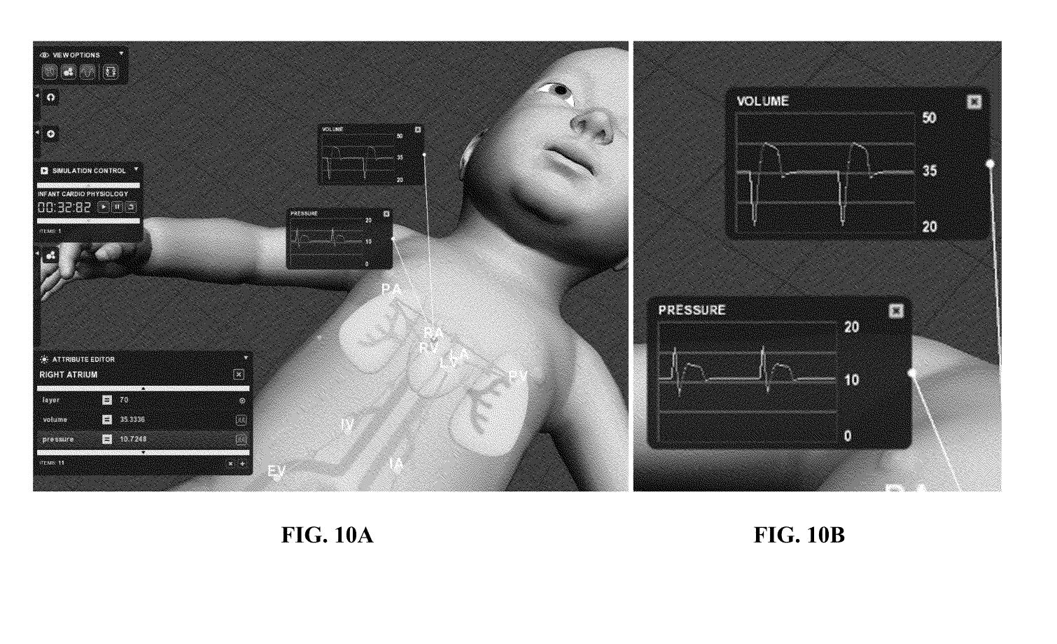

Once the model is running, users can choose to add plots of different variables to the visualization by dragging the desired variables from the attribute menu into the scene. The plots are connected to the nodes which they represent and stay rooted to them in 3D space (i.e., when the camera moves the plot will maintain its 2D position with respect to the node). The plots for blood volume and pressure for the right atrium node are shown in FIG. 10A (with an enlarged view in FIG. 10B).

In a further embodiment, an equation repository is provided. These equations can then be applied by users to ontology nodes as an attribute in order to simulate different physiological processes or pathologies (e.g., the change of blood volume with respect to time).

As another example, a physiology learning module of an adult human was created as part of a prototype. According to this embodiment of the invention, three model types are integrated for the CV physiology scenarios: (1) a model of an adult human with anatomy related to shock; (2) an FMA-based ontology that links the anatomical components to dynamic compartments, and (3) a compartmental model of the CV system.

For the adult human prototype, additional features (as compared to the infant prototype) are included. These features include allowing visualizations of ontological relationships to trace arbitrary 3D paths; and adding the concept of influences to link simulation variables to visualization parameters.

A simulation and visualization of hypovolemic shock was constructed for the adult human prototype. Hypovolemic shock is a type of shock resulting from severe blood loss. Symptoms of hypovolemic shock include vasoconstriction (resulting in a de-coloring of the skin), an increased heart rate, and a weakened pulse.

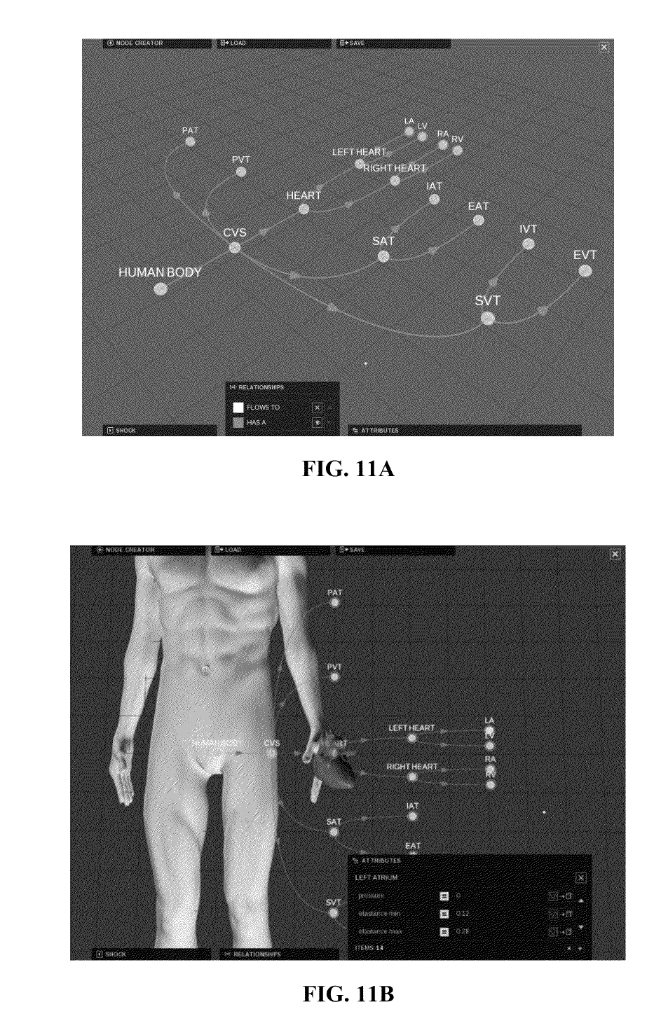

Starting again with steps 1 and 2 (as described above), a simulation model is constructed by first obtaining an ontology. For example, a domain-ontology is either acquired or built. For the adult human example, the FMAO portion related to cardiovascular function illustrated in FIG. 3 is leveraged. Here, additional concepts of intrathoracic arterial tree, extrathoracic arterial tree, intrathoracic venous tree, and extrathoracic venous tree are added to this sub-ontology to further compartmentalize the concepts systemic arterial tree and systemic venous tree. FIG. 11A shows the base ontology (from FIG. 3) and the four additional concepts as visualized in the prototype's interface.

In the visualization, CVS: Cardiovascular system, PAT: pulmonary arterial tree, PVT: pulmonary venous tree, SAT: Systemic arterial tree, SVT: systemic venous tree, IAT: intrathoracic arterial tree, EAT: extrathoracic arterial tree, IVT: intrathoracic venous tree, EVT: extrathoracic venous tree, LA: left atrium, LV: left ventricle, RA: right atrium, RV: right ventricle. Here, the abbreviations are illustrated to minimize clutter on the screen. However embodiments of the invention are not limited to these or other abbreviations, and in certain embodiments abbreviations are optional, may not be provided, or may be selectively employed as needed.

For step 3 (as described above), the result of assigning mesh and material attributes to the concepts human body and heart is shown in FIG. 11B. The assignment of these visualization attributes marks the transition to the simulation and visualization construction phase of the methodology. For meshes and material stored in the OGRE format, the meshes can be moved once loaded into the system by using a mover widget. The mover widget can appear rooted at the visualization of a selected ontology node that allows users to reposition the meshes in 3D space.

Many cardiovascular simulation models utilize the hydrodynamics metaphor through compartmental modeling. In such models, chambers of the cardiovascular systems are represented by a series of inter-connected compartments. Inter-connections are supplemented with valves and resistances to modify flow; and blood levels are governed over time by differential equations that account for pressure, flow, valves and resistances. Blood is propagated through the compartments by a periodic pump function connected to the heart compartments. In accordance with certain embodiments of the invention, an equation solver is provided that solves the network of dynamic relationship according to the hydrodynamics metaphor. Ontological concepts are given attributes that are in turn used as coefficients in the flow equations, which are solved using forward Euler's method.

Moving along to step 4, along with the assigning of visualization parameters to ontology concepts, simulation variables need to be defined. In this prototype, simulation variables were taken from the cardiovascular model created by Beneken (1965). Each compartment in the model has a blood volume level that is updated according to pressure and inward and outward flow. Flow is calculated by considering resistances between compartments and valves. FIG. 11B shows the expanded Attribute Editor with attributes pressure, elastance min, elastance max which were added to left atrium. The Attributes Editor allows the users to add and remove attributes to ontology concepts. In order for the mathematical solver to execute the simulation model, all the necessary simulation attributes are added to the concepts of the cardiovascular model. Further, relationships of type flows to are added between the compartments in order to determine the cardiovascular network that is to be solved when the simulation is executed.

Resistance between compartments is a required variable for the hydrodynamic equation solver. Instead of requiring an out-resistance or in-resistance attribute be added to the ontology concepts, this variable is linked to the actual relationship connecting the compartments, as this relationship visually represents the flow. To this end, an embodiment of the invention allows attributes to be assigned to relationships as well. Resistance values for the Beneken model are defined as attributes added to the relationships connecting the 10 compartments. This is achieved by selecting the relationship and adding attributes using the Attribute Editor. The attribute has valve is also added to flows to relationships to signify a valve exists between two compartments.

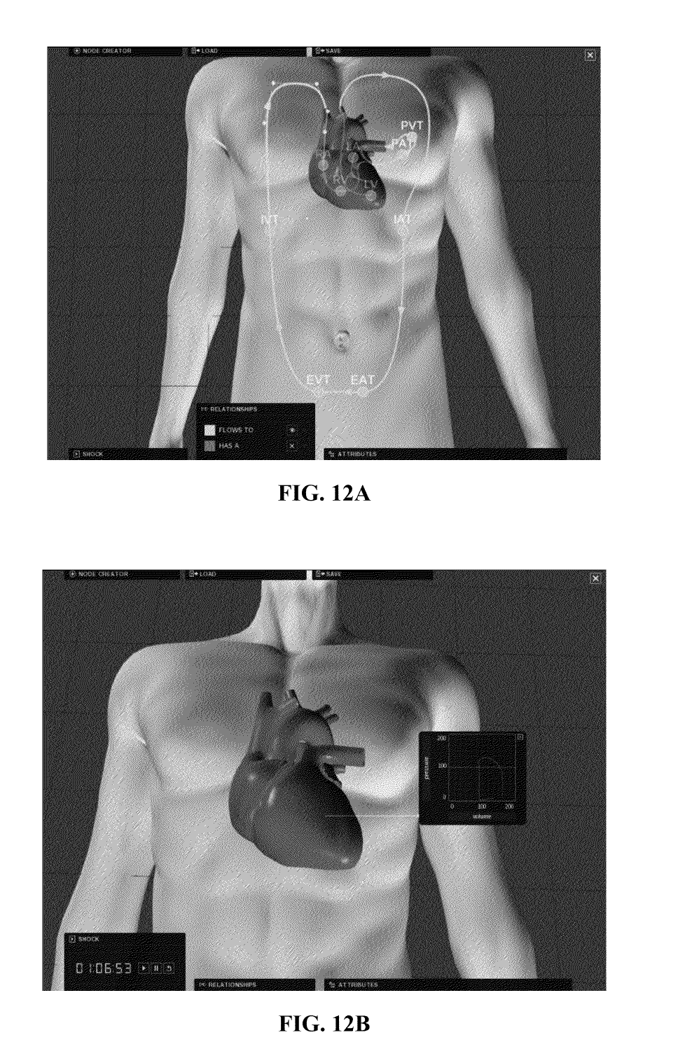

FIG. 12A shows the 10 compartment Beneken model collocated within the 3D visualization. Ontology concepts are positioned by the user and collocated with their respective locations on the 3D heart mesh. In this example, compartments representing sprawling, non-centralized anatomy are placed within the visualization in a symbolic fashion (e.g., intrathoracic arterial tree is placed somewhere within the thorax). As also depicted in FIG. 12A, ontological relationships can be collocated within the 3D visualization. This is possible because relationships are rendered as splines, which are smooth interpolations of piece-wise linear polynomials. In FIG. 12A, the spline control hull is visible for the relationship connecting the intrathoracic venous tree (IVT) to the right atrium (RA). Control points (the white spheres) on the curve's hull can be selected and positioned in the 3D space and the curvature of the relationship will update accordingly. Representing relationships as 3D curves allows the ontology visualization to positionally express dynamic flow between ontology members (e.g., the relationships trace the 3D path of blood flow through the heart).

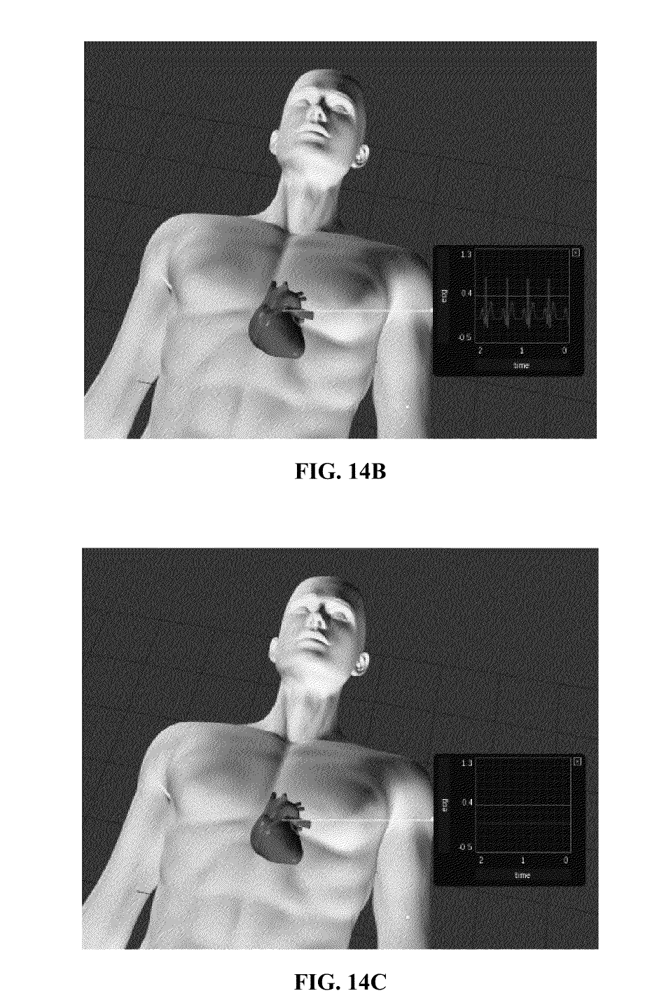

Moving along to step 5, with the appropriate variables added to the ontology and the cardiovascular network defined, the simulation model can be executed. For the prototype, the simulation model can be executed by pressing play in the Simulation Controller (shown in the bottom left corner of FIG. 12B). Simulation variables can be selected from the Attribute Editor and placed within the visualization. This is also demonstrated in FIG. 12B, where the pressure attribute of the left ventricle was placed in the 3D scene, resulting in a plot anchored to the left ventricle ontology concept. The volume attribute was then dragged to the x-axis of the pressure plot to replace the default x value of time. This resulted in the pressure-volume loop during simulation execution shown in FIGS. 14A-14C.

In the construction of the simulation model of hypovolemic shock, blood loss is introduced to the system. A linear rate of change can be introduced to any variable by adding attributes to ontology members of the form variable_name decrease rate or variable_name increate rate. Variable_name is the name of a variable that is defined within the same concept as the rate of change. In the case study, the variable volume decrease rate was added to the concept intrathoracic arterial tree (IAT) and its value set to 25. This results in the blood volume in the intrathoracic arterial tree to be drained at a rate of 25 milliliters per second during simulation execution.

It should be understood that this introduction of blood loss to simulate hemorrhaging during shock is a simplistic approach used to explain the prototype and scenario construction. Currently, linear relationships are defined to link attributes within the ontology for the simulation tool. In the prototype, the stages are hard-coded into the equation solver so when blood loss reaches certain levels, the variable heart rate of the concept heart is updated accordingly. However embodiments are not limited thereto. For example, semantics may be incorporated so that so that phenomena such as the stages of hypovolemic shock can be integrated into simulation models.

Once a simulation model is defined, it can be executed in the viewing portion of the prototype. In addition, integrative multimodeling is enabled by allowing the simulation and knowledge models to be visualized along with the more concrete geometric models (i.e., the textured 3D meshes). The ontology can also serve to connect simulation variables to visualization parameters resulting in dynamic 3D animations based on simulation behavior.

By adding influence attributes to ontology concepts in accordance with certain embodiments of the invention, the value of one attribute is linked to another by mapping between linear ranges during simulation execution. To create the semantic link in the ontology, attributes influence source, influence destination, influence source range, and influence destination range are included. Ranges can be bounded by either vector or scalar values.

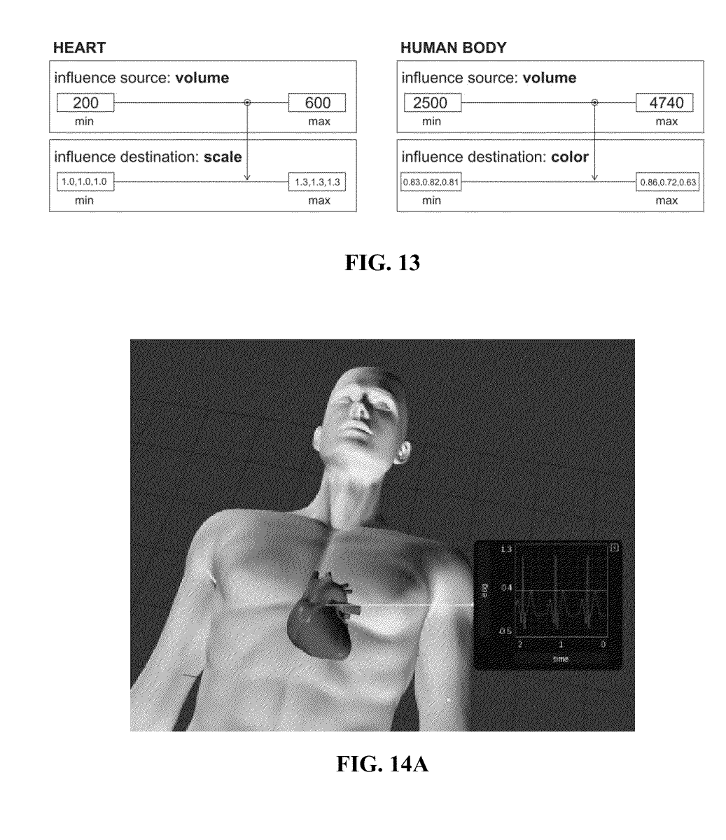

The two influences in the hypovolemic shock case study are shown in FIG. 13. The volume of the heart (calculated by summing the volume of all the heart's subcomponents) is linked to the scale. The volume of the heart in the range (200 ml, 600 ml) is mapped to a scale in the range ([1.0,1.0,1.0], [1.3,1.3,1.3]). This results in a beating effect that can visually relay the pulse frequency and strength. As also depicted in FIG. 13, total blood volume is mapped to the color of the skin. The blood volume influence ranges from 4240 ml (normal amount of blood for an adult male) to 2500 ml. The skin colors ranges from [red: 0.83, green: 0.82, blue: 0.81] (very pale) to [red: 0.86, green: 0.72, blue: 0.63] (a typical Caucasian skin tone). The result of these influence additions are shown in FIGS. 14A-14C, where three snap shots are taken while the simulation is executing.

In a further embodiment, the influence source can be related to the output of equations that are listed as attributes. Consider, for instance, the electrocardiograph (ECG). The ECG is frequently used in clinical practice to monitor heart activity. In one embodiment, ECG behavior can be represented by a single set of differential equations with the attribute heart rate as a coefficient, which can enable the assigning of those equations as attributes to ontology members. The equations would need to be solved at the same frequency that the general hydrodynamic solver solves its differential equations. To illustrate this methodology, an ECG model was included and the equations in the model solved. Total blood volume is used to scale the ECG output (much like it is used to color the skin of the human body). This linkage results in a weakened ECG signal as blood is drained, as depicted in the ECG plots in FIGS. 14A-14C (note that ECG eventually flat-lines because the heart stops beating after 50% total blood loss occurs). Clearly, a medical researcher would desire a more sophisticated and accurate linkage of physiological parameters to ECG output, but this example demonstrates how using equations as attributes could enable executable ontology-based simulation models that cross mathematical paradigms.

In accordance with certain embodiments of the invention, ontology visualizations are provided at the user interface level to support simulation model building and visualization construction activities. The visualization of an ontology serves as an anchor for other 3D visualization elements such as meshes and variable plots. Through the use of splines, relationship visualization can be sculpted to trace a meaningful 3D path within the visualization environment.

Although certain embodiments of the subject viewers enable interaction and manipulation of variables, certain implementations of the subject viewers can restrict a user's action. For example, a user would be able to view the integrative visualizations but not change any attributes or concepts in the ontology. A traditional two-dimensional “textbook” view of the dynamic model can also be made available in the interface. The 2D and 3D views will be co-interactive in that selecting model components in one view would cause the same model component to become highlighted in the alternate view. Such a visualization may help link concrete and abstract knowledge.

Certain techniques set forth herein may be described in the general context of computer-executable instructions, such as program modules, executed by one or more computers or other devices. Generally, program modules include routines, programs, objects, components, and data structures that perform particular tasks or implement particular abstract data types. In various embodiments, the functionality of the program modules may be combined or distributed as desired over a computing system or environment.

The methods and processes described herein can be embodied as code and/or data. The software code and data described herein can be stored on one or more computer readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium.

In accordance with embodiments of the invention, computer-readable media can be any available computer-readable storage media or communication media that can be accessed by a computer system.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” should not be construed or interpreted to include any carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Those skilled in the art will appreciate that the techniques described herein may be suitable for use with other general purpose and specialized purpose computing environments and configurations. Examples of computing systems, environments, and/or configurations include, but are not limited to, personal computers, server computers, hand-held or laptop devices, multiprocessor systems, microprocessor-based systems, programmable consumer electronics, and distributed computing environments that include any of the above systems or devices.

In certain embodiments, the simulation tools are employed in a computing environment including a general-purpose computing system in the form of a computer, or a mobile communication or tablet device. The computer may include one or more processors or processing units, memory, and system bus for facilitating communications between system components including the processors and memory. A monitor or other display device can be connected to the system bus via an interface. The computer can also include a variety of input devices for enabling a user to enter commands and information into the computing system. Removable and non-removable computer-readable media can be provided.

The computing system may operate in a networked environment. The network can be, but is not limited to, a cellular (e.g., wireless phone) network, the Internet, a local area network (LAN), a wide area network (WAN), a WiFi network, or a combination thereof. In addition, aspects of the invention can be presented as a service hosted on a server and accessed by client devices.

It should be understood that the examples and embodiments described herein are for illustrative purposes only and that various modifications or changes in light thereof will be suggested to persons skilled in the art and are to be included within the spirit and purview of this application.

What is claimed is:

1. A simulation authoring and viewing system, comprising:
an ontology editor module that receives an ontology file and allows a user to create or augment the ontology file and connect concepts in the ontology file to an appropriate relationship type;
an attribute module that enables a user to select a node from the ontology file and indicate a visualization attribute and simulation attribute for the node, the visualization attribute comprising a 3D mesh and the simulation attribute comprising a simulation parameter or dynamic system model;
a pedagogical parameter module for assigning pedagogical parameters to the concepts and relationships in the ontology file; and
a simulation module.

2. The system of claim 1, wherein the simulation module executes a simulation created by the ontology editor module, attribute module, and pedagogical parameter module and enables a user to play, pause, and reset the simulation.

3. The system of claim 1, wherein the relationship type comprises “has a” or “is a” relationship type.

4. The system of claim 1, wherein the ontology file comprises an ontology associated with human anatomy.

5. The system of claim 4, wherein the attribute module comprises an attributes editor for adding and removing attributes of a cardiovascular simulation model.

6. The system of claim 5, further comprising a mathematical solver for executing the cardiovascular simulation model.

7. A computer-readable storage medium having instructions stored thereon that when executed cause a processor to perform a method comprising:
displaying an ontology editor interface for creating nodes, forming relationships between nodes and assigning attributes to the nodes, wherein the ontology editor interface comprises an ontology model display region for displaying the nodes;
displaying a visualization of a real object with which the nodes of an ontology model is associated; and
displaying a simulation interface for running a simulation associated with the ontology model.

8. The medium of claim 7, wherein the ontology editor interface further comprises:
a mover tool for moving a selected node within the ontology model display region; and
an edge creator tool for connecting nodes with semantic or dynamic edges within the ontology model display region.

9. The medium of claim 7, wherein the ontology editor interface further comprises a node expander/contractor tool for expanding and collapsing ontology nodes being displayed in the ontology model display region.

10. The medium of claim 7, wherein the method further comprises receiving an ontology model file providing the ontology model and displaying the ontology model in the ontology model display region of the ontology editor interface.

11. The medium of claim 7, wherein the ontology editor interface further comprises an attribute tool, wherein in response to a user interaction with a node, the attribute tool causes attribute input fields to be displayed, including a selection for displaying the visualization of the real object with which the node is associated.

12. The medium of claim 11, wherein the ontology editor interface further comprises a 3D visualization mover tool for moving the visualization of the real object with which the node is associated.

13. The medium of claim 7, wherein displaying the visualization of the real object comprises displaying a 2D or a 3D visualization.

14. The medium of claim 13, wherein displaying the visualization of the real object comprises displaying a morphing between the 2D visualization and the 3D visualization.

15. A method comprising:
receiving an ontology file;
displaying the ontology file within an authoring interface that allows a user to:
create or augment the ontology file and connect concepts in the ontology file to an appropriate relationship type;
select a node from the ontology file and indicate a visualization attribute and simulation attribute for the node, the visualization attribute comprising a 3D mesh and the simulation attribute comprising a simulation parameter or dynamic system model; and
assign pedagogical parameters to the concepts and relationships in the ontology file;
displaying a simulation interface that allows a user to interact with a simulation created via the authoring interface; and
executing the simulation.

16. The method of claim 15, wherein displaying the ontology file within the authoring interface comprises:
displaying an ontology editor interface for creating nodes, forming relationships between nodes and assigning attributes to the nodes defined by the ontology file, wherein the ontology editor interface comprises an ontology model display region for displaying the nodes; and
displaying a visualization of a real object with which the nodes of an ontology model is associated.
